(19) United States
(12) Patent Application Publication
(10) Pub. No.: US 2024/0368401 A1
(43) Pub. Date: Nov. 7, 2024

(54) TOUGHENED POLYAMIDE

(71) Applicants: Dow Global Technologies LLC, Midland, MI (US); Dow Silicones Corporation, Midland, MI (US)

(72) Inventors: Tao Wang, Shanghai (CN); Hongyu Chen, Shanghai (CN); Xilun Weng, Shanghai (CN); Kainan Zhang, Shanghai (CN); Ming Ming, Shanghai (CN); Wenke Miao, Shanghai (CN); Wuye Ouyang, Shanghai (CN); Andong Liu, Shanghai (CN)

(21) Appl. No.: 18/687,855

(22) PCT Filed: Nov. 15, 2021
(86) PCT No.: PCT/CN2021/130742

§ 371 Date: Feb. 29, 2024

(51) Int. Cl. C08L 77/02; C08J 3/00

(52) U.S. Cl. CPC C08L 77/02; C08J 3/005; C08J 2377/02; C08J 2423/26; C08J 2483/04

(57) ABSTRACT

Toughened polyamide composition including: (a) at least one polyamide; (b) at least one toughener component; and (c) at least one siloxane-based component having a viscosity of 1 mm²/s-100,000 mm²/s providing toughened polyamide composition with good impact strength; process for producing the toughened polyamide composition; and articles made from the toughened polyamide composition.

### FIELD

The present invention relates to toughened polyamide compositions; and more specifically, the present invention relates to toughened polyamide compositions comprising blends of a polyamide, an impact modifier, and a siloxane-based polymer that provide the toughened polyamide compositions with improved impact strength and flowability properties.

### BACKGROUND

Nylon is a generic designation for a family of synthetic thermoplastic polymers composed of polyamides. Polyamides (PA) are repeating units linked by amide links. Nylon is a well-known synthetic thermoplastic polymer based on aliphatic or semi-aromatic polyamides in which at least 85% by weight of the amide-linkages (—CO—NH—) are attached directly to two aliphatic groups.

The synthetically engineered nylon (or PA) is a plastic with excellent mechanical properties, solvent resistance, wear resistance, and the like; and nylon material can be melt-processed into various fibers, films, or shapes for forming articles/products and parts for use in various applications. For example, toughened nylon composites can be used in applications such as automotive applications, industrial machinery applications, consumer applications, and electronic applications. There continues to be a need to improve the impact strength of toughened nylon at both room temperature and temperatures lower than room temperature, especially in the automotive field. However, nylon has a low notched impact strength, and particularly, nylon exhibits a disadvantage of poor toughness in a low-temperature environment, which limits further applications of nylon in the industry. Therefore, the industry is constantly seeking ways to better (increase or improve) the impact strength performance of toughened nylon.

Typically, the impact strength performance (or impact resistance) of toughened nylon is increased by adding impact modifier (IM) agents or additives to the toughened nylon. Adding an impact modifier material to the toughened nylon is one method to improve the impact strength of toughened nylon at both room temperature and temperatures lower than room temperature, especially in the automotive field. Still, more efficient impact modifiers are required to enable reducing further the weight of an article made from the toughened nylon as a more efficient impact modifier can improve the stiffness/toughness/flowability balance of the toughened nylon and reduce the costs involved in fabricating the toughened nylon and articles made therefrom.

Heretofore, the impact modifier (IM) predominantly used in toughened nylon has been maleic anhydride grafted polyolefin elastomers. Usually, a maleic anhydride (MAH) is grafted to the backbone of a polyolefin elastomer (POE) to boost the compatibility between the POE and nylon through the reaction between the anhydride group grafted on the POE and the amine end group in nylon as shown in the following general chemical reaction scheme, (Scheme (I)):

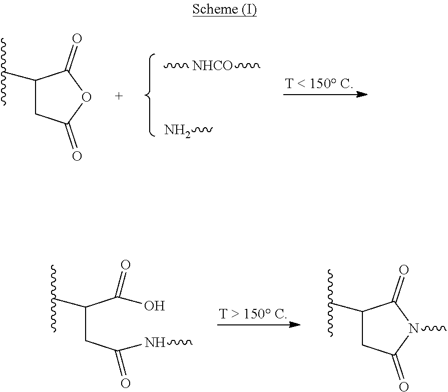

The MAH grafted POE realizes the good compatibility property needed between the non-polar polyolefin and the high polar nylon. However, the above reaction causes an irreversible imide bond and significantly decreases the flowability property of the resulting nylon/POE blend composition.

Heretofore, numerous efforts have been conducted to improve the impact strength of toughened nylon including, for example, optimizing the MAH graft ratio of the IM, reducing the Tg of the POE, and/or providing crosslinking in the POE. Most of the efforts involve the design of the MAH-grafted POE (also abbreviated as “POE-g-MAH”) component, such as modifying the MAH level grafted onto the POE. However, the efforts by the aforementioned industries to optimize both the impact strength and flowability performance of toughened nylon compositions have been met with only limited success.

For example, U.S. Pat. No. 9,056,982 B2 and U.S. Pat. No. 9,388,312 mention a thermoplastic composition in the form of a pellet or solid comprising: from 50 to 99 by weight percent of a Nylon 6.6 resin, from 1 to 50 by weight percent of a polymer performance modifier and from 0.01 weight percent to 25 weight percent of a silicone-based additive, wherein the silicone-based additive comprises an ultrahigh molecular weight siloxane polymer which cannot be considered as either a gel or an oil, and the siloxane polymer is unfunctionalized and non-reactive with the polyamide.

U.S. Patent Application Publication No. 20140316041 (equivalent to WO2014176143A1) mentions the use of an ultra high molecular weight polydimethylsiloxane (PDMS) as toughener in thermoplastic or thermoset resin systems. The resin system described in the above reference covers a wide range of types of polymers and polyamides. The precipitated silica and fumed silica are blended in PDMS as well. The loading of PDMS is high and in the range of from 20% to 80% by weight in the composition disclosed in the above reference. Such a high loading of PDMS can be detrimental to the resin systems using the PDMS because of poor compatibility between high polar polyamide and low polar PDMS.

CN 110437611A mentions a toughened nylon composite with ultra-low temperature resistance. The composite described in the above reference requires an amino or epoxy terminated PDMS as a toughener in addition to glass fiber, lubricant, and other additives. No polyolefin elastomer is mentioned as being useful as a toughener. In addition, the above reference requires a high loading (e.g., 5 wt % to 12 wt %) of a toughener based on the total formulation.

CN 102964822A mentions toughening nylon by using vinyl-PDMS with at least 2 vinyl groups as a toughener for the nylon. Hydrogen silicon oil is also used as a crosslinker. The vinyl groups are required to be present in the PDMS to be crosslinked with the hydrogen silicon oil.

CN 111117223A mentions automobile bearing materials made from nylon composites containing regenerated nylon; and from 1-10 parts of a second component polymer uses an ultra high molecular weight (Mw) PDMS together with an ultra-high Mw PE, PU, ethylene-propylene copolymer and the like. The purpose disclosed in CN 111117223A is to reduce the water adsorption of the nylon composite. Nothing in CN 111117223A describes improving impact strength or flowability or using a PDMS for improving impact strength or flowability.

In view of the limitations on the impact strength provided by the known toughened nylon compositions, it is desired to further improve the impact strength of toughened nylon, especially at low temperatures such as below −30° C., without deleteriously affecting other properties of the toughened nylon such as flowability of the toughened nylon; and without significantly increasing the cost of manufacturing the toughened nylon.

In addition, it is desired to provide a novel toughened nylon compound, material or composition having improved properties such as an increase in toughness by blending the proper components that form the improved toughened nylon composition.

### SUMMARY

In one broad embodiment, the present invention is directed to a toughened polyamide composition including a blend of: (a) at least one polyamide (e.g., a nylon compound); (b) at least one impact modifier; and (c) at least one liquid low viscosity siloxane-based polymer to form a toughened nylon composition such that the impact strength property of the toughened polyamide composition is improved.

In another embodiment, the toughened polyamide composition of the present invention includes at least one polyamide, component (a), having a concentration of from 50 wt % to 98.99 wt %; at least one impact modifier composition, component (b), having a concentration of from 1 wt % to 50 wt %; and at least one liquid low viscosity siloxane-based polymer, component (c), having a concentration of from 0.01 wt % to 10 wt % based on the total weight of toughened polyamide composition.

In still another embodiment, the present invention includes a process for preparing the above toughened polyamide composition exhibiting an improvement (e.g., at least a 10% increase) in impact strength property.

In yet another embodiment, the present invention includes a process for manufacturing the above toughened nylon composition having an improved impact strength property.

In even still another embodiment, the present invention includes an article manufactured using the above toughened polyamide composition having an improved impact strength property.

In one or more other embodiments, the present invention includes an article produced using the above toughened nylon composition; and a process for producing the article.

Additional features and advantages of the embodiments of the present invention are set forth in the detailed description which follows, and in part will be readily apparent to those skilled in the art from that description or recognized by practicing the embodiments described herein, including the detailed description and the claims.

### DETAILED DESCRIPTION

Temperatures herein are in degrees Celsius (° C.).

“Room temperature (RT)” and/or “ambient temperature” herein means a temperature between 20° C. and 26° C., unless specified otherwise.

An “elastomer” is a polymer with viscoelasticity (i.e., both viscosity and elasticity) and with weak intermolecular forces, generally low Young's modulus and high failure strain compared with other materials. IUPAC (International Union of Pure and Applied Chemistry) defines the term “elastomer” as a “polymer that displays rubber-like elasticity.”

A “polymer” is a polymeric compound prepared by polymerizing monomers, whether of the same or a different type. The generic term polymer thus embraces the term “homopolymer” (employed to refer to polymers prepared from only one type of monomer, with the understanding that trace amounts of impurities can be incorporated into the polymer structure), and the term “interpolymer,” which includes copolymers (employed to refer to polymers prepared from two different types of monomers), terpolymers (employed to refer to polymers prepared from three different types of monomers), and polymers prepared from more than three different types of monomers. Trace amounts of impurities, for example, catalyst residues, may be incorporated into and/or within the polymer. It also embraces all forms of copolymer, e.g., random, block, and the like. It is noted that although a polymer is often referred to as being “made of” one or more specified monomers, “based on” a specified monomer or monomer type, “containing” a specified monomer content, or the like, in this context the term “monomer” is understood to be referring to the polymerized remnant of the specified monomer and not to the unpolymerized species. In general, polymers herein are referred to as being based on “units” that are the polymerized form of a corresponding monomer.

The term “composition” refers to a mixture of materials which comprise the composition, as well as reaction products and decomposition products formed from the materials of the composition.

A “nylon polymer composition” herein means a combination, mixture or blend of at least one pure nylon polymer and at least one or more other material, e.g., elastomers, glass fiber, small molecular additives, and the like. The type of blending used to blend the above materials is commonly, but not limited to, proceeded by twin screw extruder or soaking.

An “impact modifier” herein means additives added for increasing flexibility, toughness, and impact strength of a variety of plastics resins to meet physical property requirements of rigid parts.

The terms “impact toughness”, “impact strength”, and “impact resistance”, with reference to a nylon composition, herein mean the performance property of impact strength of the nylon composition evaluated by the Impact Method described in CHARPY, ISO 179. The above terms can be used interchangeably.

“Room temperature (RT) impact strength”, with reference to a nylon composition, herein means an impact strength value of the nylon composition tested under room temperature conditions.

The terms “comprising,” “including,” “having,” and their derivatives, are not intended to exclude the presence of any additional component, step or procedure, whether or not the same is specifically disclosed. In order to avoid any doubt, all compositions claimed through use of the term “comprising” may include any additional additive, adjuvant, or compound, whether polymeric or otherwise, unless stated to the contrary. In contrast, the term “consisting essentially of” excludes from the scope of any succeeding recitation any other component, step, or procedure, excepting those that are not essential to operability. The term “consisting of” excludes any component, step, or procedure not specifically delineated or listed. The term “or,” unless stated otherwise, refers to the listed members individually as well as in any combination. Use of the singular includes use of the plural and vice versa.

The numerical ranges disclosed herein include all values from, and including, the lower and upper value. For ranges containing explicit values (e.g., a range from 1, or 2, or 3 to 5, or 6, or 7), any subrange between any two explicit values is included (e.g., the range 1 to 7 above includes subranges 1 to 2; 2 to 6; 5 to 7; 3 to 7; 5 to 6; and the like.).

As used throughout this specification, the abbreviations given below have the following meanings, unless the context clearly indicates otherwise: “=” means “equal(s)” or “equal to”; “<” means “less than”; “>” means “greater than”; “≤” means “less than or equal to”; “≥” means “greater than or equal to”; “@” means “at”; μm=micron(s), g=gram(s); mg=milligram(s); mW/m-K=milliwatt(s) per meter-degree Kelvin; L=liter(s); mL=milliliter(s); g/mL=gram(s) per milliliter; g/L=gram(s) per liter; g/10 min=grams per 10 minutes; kg/m³=kilogram(s) per cubic meter; ppm=parts per million by weight; pbw=parts by weight; rpm=revolutions per minute; m=meter(s); mm=millimeter(s); cm=centimeter(s); m=micrometer(s); mm²/s=millimeter(s) squared per second; min=minute(s); s=second(s); ms=millisecond(s); hr=hour(s); Pa=pascals; MPa=megapascals; Pa-s=Pascal second(s); mPa-s=millipascal second(s); g/mol=gram(s) per mole(s); g/eq=gram(s) per equivalent(s); mg KOH/g=milligrams of potassium hydroxide per gram(s); Mn=number average molecular weight; Mw=weight average molecular weight; pts=part(s) by weight; 1/s or sec-¹=reciprocal second(s) [s-¹]; ° C.=degree(s) Celsius; mmHg=millimeters of mercury; psig=pounds per square inch; kPa=kilopascal(s); %=percent; vol %=volume percent; mol %=mole percent; and wt %=weight percent.

Unless stated otherwise, all percentages, parts, ratios, and the like amounts, are defined by weight. For example, all percentages stated herein are weight percentages (wt %), unless otherwise indicated.

Specific embodiments of the present invention are described herein below. These embodiments are provided so that this disclosure is thorough and complete; and fully conveys the scope of the subject matter of the present invention to those skilled in the art.

In general, the present invention includes a toughened polyamide (e.g., nylon) formulation or composition useful for producing nylon articles/products or parts for various applications; and particularly in applications where the nylon composition requires having an increase in impact strength and flowability properties.

In a broad embodiment, the toughened polyamide composition of the present invention includes a blend or mixture of: (a) at least one polyamide (e.g., a nylon compound); (b) at least one toughener component; and (c) at least one liquid low viscosity siloxane-based polymer to form a toughened nylon composition such that the impact strength property of the toughened polyamide composition is improved.

The polyamide compound, component (a) of the nylon composition, is a polymer, which contains recurring amide groups (R—CO—NH—R′) as integral parts of the main polymer chain.

The polyamide compound useful in the present invention can include one or more polyamide compounds. Suitable polyamide resins that may be used for the present invention include any known polyamides in the art. The polyamides useful in the present invention include, for example but are not limited to: aliphatic, semicrystalline, aromatic, semi-aromatic nylon resins, and mixtures thereof. The nylon resins are those prepared from starting materials of essentially a lactam or a diamine; an aliphatic, semi-aromatic or aromatic dicarboxylic acid; and mixtures thereof. Suitable lactams useful in the present invention include, for example, caprolactam; laurolactam; and mixtures thereof. Suitable amines useful in the present invention include, for example, tetramethylenediamine; hexamethylenediamine (HMD); 2-methylpentamethylene-diamine; undecamethylenediamine; dodecamethylenediamine; 2.2.4-(2,4,4-trimethyl-hexamethylenediamine; 5-methylnonamethylenediamine; metaxylylenediamine (XD); paraxylylenediamine; 2-methyl-1,5-pentamethylenediamine (PMD); and mixtures thereof. Suitable dicarboxylic acids useful in the present invention include, for example: adipic acid, suberic acid, azelaic acid, sebacic acid, dodecanedioic acid (DDDA), terephthalic acid (TPA), isophthalic acid (IPA), 2-chloroterephthalic acid, 2-methylterephthalic acid, 5-methylisophthalic acid, 5-sodium-sulfoisophthalic acid, hexahydroterephthalic acid, hexahydroisophthalic acid, and mixtures thereof.

In the present invention, nylon homopolymers or copolymers to be derived from the above starting materials are used either singly or as mixtures. Specific examples of polyamide resins that are desirable for compositions of the present invention include: (Nylon 6); polyundecanamide (Nylon 11); polylauramide (Nylon 12); polyhexamethylenadipamide (Nylon 66); polytetramethylenadipamide (Nylon 46); polyhexamethylenesebacamide (Nylon 610); polyhexamethylenedodecamide (Nylon 612); polyhexamethyleneterephthalamide (6T); polyhexamethylenisophthalamide (61); 2-methylpentamethylene terephthalamide (Nylon DT); 2-methylpentamethylene isophthalamide (DI); polyhexamethyleneterephthalamide/polycapramide copolymer (Nylon 6T/6); polyhexamethyleneterephthalamide/polydodecanamide copolymer (Nylon 6T/12); polyhexamethylenadipamide/polyhexamethyleneterephthalamide copolymer (Nylon 66/6T); polyhexamethylenadipamide/polyhexamethylenisophthalamide copolymer (Nylon 66/61), polyhexamethylenadipamide/polyhexamethylenisophthalamidef-polycapramide copolymer (Nylon 66/61/6); polyhexamethylenadipamide/polyhexamethyleneterephthalamide/-polyhexamethylenisophthalamide copolymer (Nylon 66/6T/61); polyhexamethylene terephthalamide/polyhexamethylenisophthalamide copolymer (Nylon 6T/61); polyhexamethyleneterephthalamide/poly(2-methylpentamethylene)terephthalamide copolymer (Nylon 6T/M5T); polyhexamethyleneterephthalamidef-polyhexamethylene sebacamide/polycapramide copolymer (Nylon 6T/610/6); polyhexamethylene terephthalamide/polydodecanamide/polyhexamethylenadipamide copolymer (Nylon 6T/12/66); polyhexamethyleneterephthalamide/polydodecanamide/-polyhexamethylenisophthalamide copolymer (Nylon 6T/12/61); poly m-xylylenadipamide (Nylon XD6); and mixtures and copolymers of any of the above compounds; and the like.

In some preferred embodiments, the polyamide component, component (a), may be any polyamide for which impact strength is desired. For example, the polyamide component can be selected from the group consisting of: (ai) Nylon-6; (aii) Nylon-4,6; (aiii) Nylon-6,6; (aiv) Nylon-6,10; (av) Nylon-6,9; (avi) Hylon-6,12; (avii) Nylon-7; (aviii) Nylon 10; (aix) Nylon-10, 10, (ax) Nylon-11; (axi) Nylon-12; (axii) Nylon-12,12; (axiii) 6T through 12T; (axiv) 61 through 121; (axv) polyamides formed from 2-methylpentamethylene diamine and/or from hexamethylene diamine with one or more acids selected from the group consisting of adipic acid, isophthalic acid and terephthalic acid; (axvi) blends and/or copolymers of said nylons and polyamides thereof; and (axvii) mixtures thereof.

In other preferred embodiments, the polyamide can be selected from the group consisting Nylon 6 (a polycaprolactam which is made from caprolactam which self-polymerizes); Nylon 6,6 (a hexamethylene diamine—adipic acid condensation product which is a long chain synthetic polyamide having recurring amide groups in the polymer backbone); Nylon 4; Nylon 11; Nylon 6,10; and combinations thereof.

In still other preferred embodiments, the polyamide compound useful in the present invention include Nylon 6; Nylon 6,6; and mixtures thereof.

In some embodiments, the polyamide component, component (a), can be selected from commercially available compounds such as Ultramid series products (available from BASF). In other embodiments, exemplary of some of the commercial polyamide compounds useful in the present invention can include, for example, Zytel 7304 NC010 (available from Dupont); PA6-YH800 (available from Yueyang Baling Shihua Chemical & Synthetic Fiber Co. Ltd.); and mixtures thereof.

The concentration of the polyamide component, component (a), can be from 50 wt % to 98.99 wt % in one embodiment, from 70 wt % to 92 wt % in another embodiment, from 75 wt % to 90 wt % in still another embodiment.

The toughener component (b) (or impact modifier component) useful in the present invention composition can be selected from, for example, a maleic anhydride-grafted polyolefin elastomer; an amine or carboxylic acid functionalized polyolefin; an ionomer comprising the metal salts of carboxylic acid functionalized polyolefin; and mixtures thereof.

In some embodiments, the toughener component, component (b), is selected from the group consisting of, for example: (bi) at least one polymer consisting essentially of polymerized ethylene, at least one polymerized α-olefin of 3 carbon atoms to 12 carbon atoms and at least one polymerized unsaturated monomer taken from the class consisting of branched, straight chain and cyclic compounds having from 4 carbon atoms to 14 carbon atoms; (bii) an unsaturated monomer taken from the class consisting of α,β ethylenically unsaturated dicarboxylic acids having from 3 carbon atoms to 8 carbon atoms and derivatives thereof taken from the class consisting of monoesters of alcohols of from 1 carbon atom to 29 carbon atoms, anhydrides of the dicarboxylic acids, the metal salts of the dicarboxylic acids and the monoesters of said dicarboxylic acid having from 0 percent to 100 percent of said dicarboxylic acid having from 0 percent to 100 percent of carboxylic groups ionized by neutralization with metal ions; and (biii) mixtures of components (bi) and (bii) above.

In some embodiments, the toughener component (also referred to as an “impact modifier”; component (b)), comprises a maleic anhydride functionalized elastomeric ethylene copolymer, a maleic anhydride functionalized ethylene, an α olefin copolymer, a terpolymer of ethylene, acrylic ester and maleic anhydride, a maleic anhydride (MAH) grafted polyolefin elastomer (POE) and combinations thereof. In one preferred embodiment, the toughener component, component (b), is a maleic anhydride-grafted polyolefin elastomer (POE-g-MAH).

In some embodiments, the toughener component can be selected from, but is not limited to, commercially available compounds such as Exxelor series products (available from ExxonMobil); Tafmer series products (available from Mitsui Chemicals, Inc.); and mixtures thereof.

The toughener component (b), can further be characterized as having a predetermined MAH grafting ratio, melt index, molecular weight, molecular weight distribution, and/or branching before the toughener component is mixed with the nylon component (a) and the PDMS component (c). For example, the toughener component has a MAH graft ratio of from 0.1 to 5 in one embodiment; from 0.2 to 2.0 in another embodiment; and from 0.3 to 1.0 in still another embodiment. For example, the impact modifier has a density of from 0.8 g/cc to 0.95 g/cc in one embodiment; from 0.83 g/cc to 0.93 g/cc in another embodiment; and from 0.85 g/cc to 0.92 g/cc in still another embodiment.

The concentration of the toughener (impact modifier) compound, component (b), used in preparing the nylon composition of the present invention includes, for example, from 1 wt % to 50 wt % based on the weight of nylon composition in one embodiment, from 8 wt % to 35 wt % in another embodiment, and from 10 wt % to 25 wt % in still another embodiment.

In some embodiments, the siloxane-based component, component (c), can include, for example, disiloxane, trisiloxane, a polydimethylsiloxane (PDMS); and mixtures thereof.

In one embodiment, the siloxane-based component is PDMS. Several types of PDMS including carbinol functionalized PDMS, carboxyl functionalized PDMS, amino functionalized PDMS and nonfunctionalized PDMS have been found to be useful in the present invention, i.e., the above selected types of PDMSs result in significant improvement on impact strength of the toughened nylon. In some embodiments, the PDMS may contain one or more functional groups such as carbonic groups including hydroxyl, amino, epoxy, carboxyl, mercapto group, and mixtures thereof. In some embodiments, the functional groups in the polydimethylsiloxane are at the end of the polydimethylsiloxane chain or at the side of polydimethylsiloxane chain. Exemplary of suitable nonfunctionalized PDMS useful in the present invention include, any one or more of the XIAMETER™ PIX-200 series products from The DOW Chemical Company.

The PDMSs having different molecular weights (Mw; identified by viscosity) have also been found to provide improvement to impact strength of the toughened nylon composition. The amino functionalized PDMS also provides additional benefits related to flowability such as capillary viscosity reduction.

In some embodiments, the siloxane-based component (PDMS) used in the present invention, can be selected from commercially available compounds such as XIAMETER™ PMX-200 (available from The Dow Chemical Company); KF series products (available from SHIN-ETSU Co. Ltd.); and mixtures thereof. In one embodiment, non-functionalized PDMSs useful in the present invention include commercial products from available from The Dow Chemical Company. In another embodiment, functionalized PDMSs useful in the present invention are commercial products available from SHIN-ETSU Co. Ltd. Although not limited thereto, the PDMS is used in liquid form as opposed to solid or a pellet.

In some embodiments, the viscosity of siloxane-based component can be from 1 mm²/s to 100,000 mm²/s in one general embodiment, from 3 mm²/s to 90,000 mm²/s in another embodiment, and from 5 mm²/s to 80,000 mm²/s in still another embodiment.

The concentration of the siloxane-based component, component (c), can be from 0.01 wt % to 10 wt % in one embodiment based on the nylon composition, from 0.1 wt % to 8 wt % in another embodiment, from 0.2 wt % to 5 wt % in still another embodiment.

In some embodiments, the toughened polyamide composition of the present invention can further include one or more optional components, additives or other agent compounds, if desired. The optional compounds, component (d), useful in the toughened polyamide composition of the present invention can include, for example, fillers, lubricants, plasticizers, pigments, dyes, antioxidants, stabilizers, nucleating agents, flame retardants, blowing agents, and mixtures thereof.

In general, the concentration of the optional compounds when used in the toughened polyamide composition includes, for example, from 0 wt % to 50 in one embodiment, from 0.01 wt % to 50 wt % in another embodiment, from 0.1 wt % to 40 wt % in still another embodiment, and from 0.1 wt % to 30 wt % in yet another embodiment.

In one general embodiment, the toughened nylon composition can be produced by combining, blending or mixing: (a) at least one polyamide (e.g., a nylon compound); (b) at least one toughener component; and (c) at least one liquid low viscosity siloxane-based polymer having a viscosity of from 1 mm²/s to 100,000 mm²/s. The resultant mixture forms the toughened nylon composition that exhibits improved impact strength properties.

As an illustration of one embodiment of the present invention, but not to be limited thereby, the general process for producing the toughened nylon composition of the present invention includes admixing, combining or blending: (a) at least one polyamide at a concentration of from 50 wt % to 98.99 wt % based on the weight of the toughened nylon composition; (b) at least one toughener at a concentration of from 1 wt % to 50 wt % based on the weight of the toughened nylon composition; (c) at least one siloxane-based polymer at a concentration of from 0.01 wt % to 10 wt %, based on the weight the toughened nylon composition; and (d) any optional components, if desired, at a concentration of less than 50 wt %, based on the weight the toughened nylon composition.

In some embodiments, the process of the present invention for preparing a toughened polyamide composition exhibiting improved toughness includes melt-mixing, in one step and at a predetermined temperature and for a predetermined period of time: the polyamide, component (a); the toughener, component (b); and the siloxane-based polymer, component (c). The one step melt-mixing step can be carried out at a melt temperature of greater than or equal to 200° C. in one embodiment, from 200° C. to 350° C. in another embodiment, and from 220° C. to 320° C. in another embodiment, and from 250° C. to 300° C. in still another embodiment. The period of time for the one step melt-mixing step can be greater than 20 s in one embodiment, from 20 s to 10 min in another embodiment, and from 30 s to 5 min in still another embodiment. In one embodiment, the melt-mixing one step process above can be carried out in at least one extruder such as a conventional twin-screw (at least 2 screws) extruder.

In other embodiments, the process of the present invention for preparing a toughened polyamide composition exhibiting high flow and toughness can include at least the following two steps: a first step of (I) mixing, at a predetermined temperature and for a predetermined period of time, at least the following two components to form a blend composite component (i.e., to form a toughener/siloxane-based polymer mixture): (α) the above-described toughener component (b) such as a POE-g-MAH; and (β) the above-described siloxane-based polymer component (c) such as a PDMS; and a second step of (II) melt-mixing: (γ) the above-described polyamide component (a); and (δ) the blend composite component from step (I) to form a toughened polyamide composition.

The mixing first step (I) can be carried out, for example, by soaking or compounding components (b) and (c) together; and then mixing the soaked or compounded components using, for example, at least one twin-screw extruder. When using a soaking process for the first mixing step (I), the temperature of the first mixing step (I) can be below 60° C. in one embodiment, from 0° C. to 60° C. in another embodiment, and from 10° C. to 55° C. in still another embodiment.

When using a soaking process, the period of time for the first mixing step (I) can be greater than 1 hr in one embodiment, from 1 hr to 48 hr in another embodiment, and from 2 hr to 24 hr in still another embodiment.

When using a compounding process for the first melt-mixing step (I), the first melt-mixing step (I) can be carried out at a temperature of greater than 100° C. in one embodiment, from 100° C. to 200° C. in another embodiment, and from 120° C. to 180° C. in still another embodiment. When using a compounding process, the period of time for the first mixing step (I) can be greater than 1 s in one embodiment, from 20 s to 10 min in another embodiment, and from 30 s to 5 min in still another embodiment.

When using a soaking process for the first mixing step (I), the temperature of the melt-mixing second step (II) can be greater than 200° C. in one embodiment, from 230° C. to 350° C. in another embodiment, and from 250° C. to 300° C. in still another embodiment. The period of time for the melt-mixing second step (II) can be greater than 1 s in one embodiment, from 20 s to 10 min in another embodiment, and from 30 s to 5 min in still another embodiment. In one embodiment, the melt-mixing second step (II) above can be carried out in at least one extruder such as a conventional twin-screw (at least 2 screws) extruder.

When using a compounding process for the first mixing step (I), the melt-mixing step (II) can be carried out at a temperature and for a period of time which can be the same as for the first mixing step (I).

In other embodiments, the process for preparing a toughened polyamide composition exhibiting high toughness can include at least the following three steps: a first step of (A) melt-mixing at least the following two components: (α) at least one toughener component, e.g., the toughener component (b) such as a POE-g-MAH; and (β) at least one siloxane-based component, e.g., the siloxane-based polymer component (c) such as a PDMS to form a toughener/siloxane-based polymer mixture; a second step of (B) pelletizing the toughener/siloxane-based polymer mixture from step (A) to form a plurality of composite pellets, and a third step of (C) melt-mixing at least the following two components to form a toughened polyamide composition: (γ) at least one polyamide; and (ε) the plurality of composite pellets from step (B). In one embodiment, the melt-mixing third step (C) above can be carried out in at least one extruder such as a conventional twin-screw (at least 2 screws) extruder.

The temperature of the melt-mixing first step (A) can be below 200° C. in one embodiment, from 100° C. to 200° C. in another embodiment, and from 120° C. to 180° C. in still another embodiment. The period of time for the mixing first step (A) can be greater than 1 s in one embodiment, from 20 s to 10 mins in another embodiment, and from 30 s hr to 5 mins in still another embodiment.

The pelletizing step (B) is carried out using conventional equipment such as a strand cutter to cut the resin, which exits the extruder, into pellets of a predetermined size.

The temperature of the melt-mixing third step (C) can be greater than 200° C. in one embodiment, from 230° C. to 350° C. in another embodiment, and from 250° C. to 300° C. in still another embodiment. The period of time for the melt-mixing third step (C) can be greater than 1 s in one embodiment, from 20 s to 10 min in another embodiment, and from 30 s to 5 min in still another embodiment.

The process embodiments of the present invention for preparing a toughened polyamide composition, and the steps thereof as described above, can be carried out by conventional equipment known to those skilled in the art. For example, the mixing of the components to form a uniform or homogeneous mixture can be carried out by known blenders or mixers such as twin-screw extruders, BUSS kneaders or batch mixers.

As described above, the toughened polyamide composition of the present invention comprises a mixture of: (a) at least one polyamide (e.g., a nylon compound), (b) at least one toughener component (e.g., a POE-g-MAH), and (c) at least one liquid low viscosity siloxane-based polymer (e.g., PDMS) having a viscosity of from 1 mm²/s to 100,000 mm²/s. The toughened polyamide composition of the present invention exhibits several advantageous benefit(s). For example, when a polyamide is mixed with a POE-g-MAH and a PDMS, the resultant toughened polyamide composition advantageously exhibits an enhancement of room temperature impact strength. In addition, in some instances the flowability of the toughened polyamide composition (nylon composition) of the present invention may also be enhanced.

Therefore, the combination of the at least one nylon; the at least one POE-g-MAH and the at least one PDMS forms the present invention toughened polyamide composition having at least an increased impact strength. In addition, the impact property of the toughened polyamide composition of the present invention can be improved while the other mechanical performances of the toughened nylon composition such as flexural modulus, tensile strength, elongation, heat distort temperature (HDT) are maintained at an optimized level when the polyamide is blended with the POE-g-MAH and PDMS to form the toughened nylon composition.

For example, in one general embodiment the toughened polyamide composition containing the toughener component (e.g., a POE-g-MAH) and the siloxane-based polymer (e.g., PDMS) advantageously exhibits at least a 10% improvement (e.g., an increase) in impact strength at room temperature (RT) or at temperatures below −30° C. compared to a nylon composition containing the toughener component (e.g., a POE-g-MAH) but not containing the siloxane-based polymer (e.g., PDMS) of the present invention. In another embodiment, the toughened polyamide composition of the present invention including the above-described toughener component and siloxane-based polymer exhibits at least a 15% improvement in impact strength compared to a polyamide composition containing the above-described toughener component but not containing the siloxane-based polymer of the present invention; and in still another embodiment, the toughened polyamide composition of the present invention, including the above-described toughener component and siloxane-based polymer of the present invention exhibits at least a 20% improvement in impact strength compared to a polyamide composition containing the above-described toughener component but not containing the siloxane-based polymer of the present invention. In yet another embodiment, the toughened polyamide composition of the present invention including the above-described toughener component and siloxane-based polymer of the present invention exhibits from 10% to 100% improvement in impact strength compared to a polyamide composition containing the above-described toughener component but not containing the siloxane-based polymer of the present invention.

It has been surprisingly found that the above improvements to RT/low temperature impact strength of the present invention toughened polyamide composition can be achieved by adding only a small amount (e.g., less than 5 wt %) of the PDMS to the toughened nylon composition. For example, a low loading (e.g., from 0.4 wt % to 2 wt %, based on the total weight of the toughened polyamide formulation) of PDMS along with the POE-g-MAH forms an effective impact modifier to improve the RT/low temperature impact strength of the present invention toughened polyamide composition compared to a high loading amount, e.g., from 20 wt % to 80 wt %, of PDMS required by known compositions in the art. Also, the molecular weight of the PDMS used in the prior art is greater than the molecular weight (determined by measuring viscosity) of the PDMS used in the present invention. In the present invention, the toughened polyamide composition does not require a PDMS of a specific molecular weight. However, in one preferred embodiment, a PDMS having a measured viscosity in the range of from 1 mm²/s to 100,000 mm²/s (which can be correlated to a low molecular weight) is desired to improve impact strength of the present invention composition.

Another advantage of the present invention nylon composition is that the nylon composition can be used to manufacture lightweight articles/products or parts with thinner walls and using less composition because of the above improved properties of impact strength (e.g., at RT and at low temperature) while maintaining the flexural modulus of the composition.

An article/product or part manufactured from the toughened nylon composition of the present invention can include, for example, electronics appliance, automotive parts, gears, and toys; and the like.

Once the components of the toughened nylon composition present invention: (a) at least one polyamide (e.g., a nylon compound), (b) at least one toughener component, and (c) at least one siloxane-based polymer are thoroughly and uniformly mixed together at, for example, a melt-mixing temperature, the resulting molten mixture can be used to form an article/product or a shaped part using conventional processes and equipment. For example, processes such as injection molding, extrusion molding, or blow molding processes can be used to form the article/product or the shaped part from the toughened nylon composition.

In one preferred embodiment, the article/product or the shaped part is produced and processed, for example, using an extrusion molding process and extrusion equipment such as a twin-screw extruder. In general, the process for producing the article from the toughened polyamide composition of the present invention includes, for example, the steps of: (1) providing a toughened polyamide composition by admixing: (a) at least one polyamide, (b) at least one toughener component, and (c) at least one siloxane-based polymer by using any one of the processes of producing the toughened polyamide composition described above; and (2) processing the composition of step (1) into an article using, for example, an extrusion process or an injection process to form the article.

To create thinner and consequently lighter parts, it is required that nylon compositions have high impact strength. The nylon composition of the present invention can exhibit an improvement in impact strength (or toughness) by using the proper components (a)-(c) to form the toughened nylon composition of the present invention while maintaining the other properties of the composition such as flexural modulus. Such high performance properties of the toughened nylon composition allow for downgauging interior and exterior parts and articles that require outstanding impact properties which are manufactured from the toughened nylon compositions of the present invention.

The impact modifier additives; the toughened nylon compositions; and the articles, products or parts produced from the toughened nylon compositions described above can be used in a wide range of polymer compositions and constructions. Generally, the toughened nylon composition of the present invention is used in applications where there is a need for parts with a high impact strength (i.e., an increased toughness and durability) over parts made from conventional copolymers. For example, but not to be limited thereby, the toughened nylon compositions can be used in the various applications and may be formed into molded articles useful in fields requiring impact resistance and strength. In one embodiment, for example the toughened nylon compositions can be used in automotive applications for manufacturing automotive rigid parts and components. The automotive products can be made by conventional polymer processing.

### Examples

The following Inventive Examples (Inv. Ex.) and Comparative Examples (Comp. Ex.) (collectively, “the Examples”) are presented herein to further illustrate the features of the present invention but are not intended to be construed, either explicitly or by implication, as limiting the scope of the claims. The Inventive Examples of the present invention are identified by Arabic numerals and the Comparative Examples are represented by letters of the alphabet. The following experiments analyze the performance of embodiments of the compositions described herein. Unless otherwise stated all parts and percentages are by weight on a total weight basis.

### Raw Materials

The raw materials (ingredients) used in the Examples to prepare the toughened nylon composite formulations included PA6 B3s, a polyamide nylon (available from BASF); and POE-g-MAH1 (0.50 weight % MAH graft level) and POE-g-MAH2 (0.90 weight % MAH graft level), maleic anhydride grafted polyolefin elastomers. POE-g-MAH1 had a melt index (MI) of 1.6 g/10 min, and POE-g-MAH2 had a MI of 1.3 g/10 min as measured by ASTM D1238 at 190° C. with a 2.16 kg load. The PDMS materials used in the Examples are described in Table I.)

TABLE I
PDMS Materials

| PDMS | Brief Description of | Viscosity | |
|---|---|---|---|
| Component | PDMS Component | (mm²/s) | Supplier |
| KF-6000 | Carbinol PDMS | 35 | SHIN-ETSU |
| KF-6001 | Carbinol PDMS | 45 | SHIN-ETSU |
| KF-8010 | Amino PDMS | 12 | SHIN-ETSU |
| X-22-161A | Amino PDMS | 25 | SHIN-ETSU |
| X-22-162C | Carboxyl PDMS | 220 | SHIN-ETSU |
| PMX-200 Fluid 10 cSt | Polydimethylsiloxane | 10 | DOW |
| PMX-200 Fluid 20 cSt | Polydimethylsiloxane | 20 | DOW |
| PMX-200 Fluid 100 cSt, | Polydimethylsiloxane | 100 | DOW |
| PMX-200 Fluid 1k cSt, | Polydimethylsiloxane | 1k | DOW |
| PMX-200 Fluid 10k cSt, | Polydimethylsiloxane | 10k | DOW |
| PMX-200 Fluid 60k cSt, | Polydimethylsiloxane | 60k | DOW |
| DOWSIL ™ SGM | Polydiorganosiloxane | >1,000k | DOW |
| 15 GUM | gum | | |

### Formulations

The toughened nylon composite formulations used in the Examples were made based on the formulations described in Tables II and III for Series 1 experiments and in Tables IV and V for Series 2 experiments.

TABLE II
Nylon Composite Formulations - Functional PDMS - Series 1

| | | PA6 | POE-g- | Carbinol | Amino | Carboxyl | |
|---|---|---|---|---|---|---|---|
| Example | PDMS | B3s | MAH1 | PDMS | PDMS | PDMS | PDMS |
| No. | Component | (g) | (g) | (g) | (g) | (g) | (wt %)* |
| Comp. Ex. A | Control | 1,200 | 300.0 | | | | 0.00 |
| | (no PDMS) | | | | | | |
| Inv. Ex. 1 | KF-6000 | 1,200 | 296.4 | 3.6 | | | 0.24 |
| Inv. Ex. 2 | KF-6000 | 1,200 | 292.9 | 7.1 | | | 0.47 |
| Inv. Ex. 3 | KF-6000 | 1,200 | 285.7 | 14.3 | | | 0.95 |
| Inv. Ex. 4 | KF-6001 | 1,200 | 293.0 | 7.0 | | | 0.44 |
| Inv. Ex. 5 | KF-6001 | 1,200 | 286.1 | 13.9 | | | 0.93 |
| Inv. Ex. 6 | KF-8010 | 1,200 | 293.4 | | 6.6 | | 0.44 |
| Inv. Ex. 7 | KF-8010 | 1,200 | 286.8 | | 13.2 | | 0.88 |
| Inv. Ex. 8 | X-22-161A | 1,200 | 292.9 | | 7.1 | | 0.47 |
| Inv. Ex. 9 | X-22-161A | 1,200 | 287.8 | | 12.2 | | 0.81 |
| Inv. Ex. 10 | X-22-162C | 1,200 | 292.9 | | | 7.1 | 0.47 |
| Inv. Ex. 11 | X-22-162C | 1,200 | 285.9 | | | 14.1 | 0.94 |

Note for Table II:
*The PDMS amount is based on the total weight of the nylon composition.

TABLE III
Nylon Composite Formulations—Non-Functional PDMS—Series 1

| | | | POE- | Non- | |
|---|---|---|---|---|---|
| | | PA6 | g- | functional | |
| Example | PDMS | B3s | MAH1 | PDMS | PDMS |
| No. | Component | (g) | (g) | (g) | (wt %)* |
| Inv. Ex. 12 | PMX-200 Fluid | 1,200 | 294.0 | 6.0 | 0.40 |
| | 10 cSt | | | | |
| Inv. Ex. 13 | PMX-200 Fluid | 1,200 | 289.5 | 10.5 | 0.70 |
| | 10 cSt | | | | |
| Inv. Ex. 14 | PMX-200 Fluid | 1,200 | 285.0 | 15.0 | 1.00 |
| | 10 cSt | | | | |
| Inv. Ex. 15 | PMX-200 Fluid | 1,200 | 292.9 | 7.1 | 0.47 |
| | 20 cSt | | | | |
| Inv. Ex. 16 | PMX-200 Fluid | 1,200 | 286.0 | 14.0 | 0.93 |
| | 20 cSt | | | | |
| Inv. Ex. 17 | PMX-200 Fluid | 1,200 | 292.5 | 7.5 | 0.50 |
| | 100 cSt | | | | |
| Inv. Ex. 18 | PMX-200 Fluid | 1,200 | 294.0 | 6.0 | 0.40 |
| | 1K cSt | | | | |
| Inv. Ex. 19 | PMX-200 Fluid | 1,200 | 294.0 | 6.0 | 0.40 |
| | 10K cSt | | | | |
| Inv. Ex. 20 | PMX-200 Fluid | 1,200 | 286.0 | 14.0 | 0.93 |
| | 60k cSt | | | | |
| Comp. | DOWSIL ™ SGM | 1,200 | 292.5 | 7.5 | 0.50 |
| Ex. B | 15 GUM | | | | |
| Comp. | DOWSIL ™ SGM | 1,200 | 286.0 | 14.0 | 0.93 |
| Ex. C | 15 GUM | | | | |

Note for Table III:
*The PDMS amount is based on the total weight of the nylon composition.

TABLE IV
Nylon Composite Formulations—Functional PDMS—Series 2

| | | PA6 | POE-g- | Carbinol | |
|---|---|---|---|---|---|
| Example | PDMS | B3s | MAH2 | PDMS | PDMS |
| No. | Component | (g) | (g) | (g) | (wt %)* |
| Comp. Ex. D | Control (no PDMS) | 1,200 | 300.0 | | 0.00 |
| Comp. Ex. E | Control (no PDMS, | 1,375 | 225.0 | | 0.00 |
| Inv. Ex. 21 | KF-6000 | 1,200 | 285.7 | 14.3 | 0.95 |

Note for Table IV:
*The PDMS amount is based on the total weight of the nylon composition.

TABLE V
Nylon Composite Formulations—Non-Functional PDMS—Series 2

| | | | | Non- | |
|---|---|---|---|---|---|
| | | PA6 | POE-g- | functional | |
| Example | PDMS | B3s | MAH2 | PDMS | PDMS |
| No. | Component | (g) | (g) | (g) | (wt %)* |
| Inv. Ex. 22 | PMX-200 Fluid 10 cSt | 1,200 | 289.5 | 10.5 | 0.70 |
| Inv. Ex. 23 | PMX-200 Fluid 20 cSt | 1,200 | 292.9 | 7.1 | 0.47 |
| Inv. Ex. 24 | PMX-200 Fluid 20 cSt | 1,200 | 286.0 | 14.0 | 0.93 |
| Inv. Ex. 25 | PMX-200 Fluid 100 cSt | 1,200 | 292.5 | 7.5 | 0.50 |
| Inv. Ex. 26 | PMX-200 Fluid 1K cSt | 1,200 | 294.0 | 6.0 | 0.40 |
| Inv. Ex. 27 | PMX-200 Fluid 1K cSt | 1,200 | 285.0 | 15.0 | 1.00 |
| Inv. Ex. 28 | PMX-200 Fluid 1K cSt | 1,375 | 220.5 | 4.5 | 0.40 |
| Inv. Ex. 29 | PMX-200 Fluid 1K cSt | 1,375 | 213.7 | 11.3 | 0.75 |
| Inv. Ex. 30 | PMX-200 Fluid 1K cSt | 1375 | 202.5 | 22.5 | 1.50 |

Note for Table V:
*The PDMS amount is based on the total weight of the nylon composition.

In general, the toughened nylon composite formulations described in Tables II to V were prepared by a first step of blending the PDMS component with the POE component followed by a second step of mixing the blended PDMS/POE components with the nylon component.

The first step of blending the PDMS component with the POE component is carried out by utilizing either the soaking procedure or the compounding procedure as described herein below.

Soaking Process to Blend PDMS with POE

The PDMSs including the PDMSs of KF-6000 (Inv. Ex. 1-3 and Inv. Ex. 21); KF-6001 (Inv. Ex. 4 and 5); KF-8010 (Inv. Ex. 6 and 7); X-22-161A (Inv. Ex. 8 and 9); X-22-162C (Inv. Ex. 10 and 11); PMX-200 Fluid 10 cSt (Inv. Ex. 12-14 and Inv. Ex. 22); PMX-200 Fluid 20 cSt (Inv. Ex. 15 and 16, and Inv. Ex. 23 and 24) and PMX-200 Fluid 100 cSt (Inv. Ex. 17 and Inv. Ex. 25); were blended with POE pellets through a soaking process. The PDMS were first mixed with POEs at room temperature and then the PDMSs were allowed to soak into, i.e., penetrate into the body of the POE pellets. The general process includes the following: 400 g of POE pellets were first placed in a 2 L plastic container; the PDMSs were then added to the container according to the weight percentage in Tables II and III. The container with the mixture of POE pellets and PDMS was shaken by hand for 5 min in different directions (up-down and left-right at similar frequencies). The shaking was then stopped, and the container was laid down, and the container was allowed to sit for 5 min. The steps of shaking and laying down the container was repeated 6 times; and then thereafter the container was kept at room temperature for another 3 hr. Alternatively, the PDMSs can be pre-mixed with POEs at RT, then placed in an auto-shaker, and allowed to shake in the auto-shaker at 60° C. and 85 rpm for 4 hr to 12 hr.

Compounding Process to Blend PDMS with POE

The PDMSs including the PDMSs of PIX-200 Fluid 1K cSt (Inv. Ex. 18, and Inv. Ex. 26 and 27); PMX-200 Fluid 1K cSt (15%) (Inv. Ex. 28-30); PMX-200 Fluid 10K cSt (Inv. Ex. 19); PMX-200 Fluid 60k cSt (Inv. Ex. 20); and DOWSIL™ SGM 15 GUM (Comp. Ex. B and C) were each blended with POE pellets through a twin-screw extruder compounding process. The PDMSs were initially blended with POE before feeding the blend into the extruder; and then, the blend was fed into the extruder. The extruder used had the following conditions/parameters:

The instrument used was a ZSK-18 twin screw extruder; the power of the extruder was 19.2 KW; the diameter, D, of the extruder was D=18 mm; the L/D ratio of the extruder was L/D=48; the temperatures of the various zones of the extruder barrel were set as follows: zone 1=60° C., zone 2=90° C., zone 3=120° C., zone 4=120° C., zone 5=120° C., zone 6=120° C., and zone 7=110° C. in the range of from RT to 150° C.; the screw speed of the extruder was 300 rpm; and the feeding rate of blend material to the extruder was 5-12 kg/hr.

After the compounding step of the PDMS and POE in the twin-screw extruder, the resultant blend of PDMS/POE compounds were cut into pellets having a diameter of from 0.5 mm to 1 mm and a length of from 2 mm to 5 mm.

Compounding of PDMS/POE Mixture into Nylon

Nylon samples were first dried in a dehumidifier for at least 4 hr at 120° C. Then the blend PDMS/POE pellets produced using the above-described processes: the “Soaking Process to Blend PDMS with POE” or the “Compounding Process to Blend PDMS with POE”, were blended with the dried nylon samples by compounding the PDMS/POE pellets and nylon samples in an extruder. The extruder used was the same extruder used to blend the PDMS with POE by compounding as described above. The conditions/parameters of the extruder for compounding the PDMS/POE pellets and nylon samples were as follows: the barrel temperatures of the extruder were set as follows: zone 1=150° C., zone 2=195° C., zone 3=260° C., zone 4=260° C., zone 5=260° C., zone 6=260° C., zone 7=250° C. in the range of from RT-˜350° C.; the screw speed of the extruder was 250 rpm; and the feeding rate of blend material to the extruder was 8-10 kg/hr.

After compounding the PDMS/POE pellets and nylon samples, the resultant compounds comprising a blend of the PDMS, the POE and nylon were cut into pellets having a diameter of from 0.5 mm to 1 mm and a length of from 2 mm to 5 mm.

### Testing Methods

The following testing methods and measurement procedures were used to test the toughened nylon compositions and the specimens prepared from the toughened nylon composition according to the following methods.

### Capillary Viscosity Test

The compounded nylon/POE samples were first dried in a dehumidifier for at least 4 hr at 120° C.; and after drying the compounded samples, the compounded samples were sealed in an aluminum bag under vacuum. The moisture content in the compounded nylon/POE samples was tested by the so-called Karl-Fischer method using an 874 Oven Sample Processor (available from Thermo-Fisher Co. Ltd.). The moisture of the compounded nylon/POE samples is recommended to be below 1,000 ppm before the samples are tested using the capillary viscosity test. The capillary rheometer instrument used for the capillary viscosity test was a Gottfert rheograph 26 (available from Gottfert Inc.). The test temperature used for the capillary viscosity test was 260° C. The capillary length used was 30 mm; and the capillary diameter was 1 mm. Shear rate used in the test was across the range of from 90 1/s to 7,000 1/s. The data described in the Tables related to viscosity is reported at a shear rate of @ 770 1/s.

### Injection Molding Process

The compounded nylon/POE pellets were first dried in dehumidifier for at least 4 hr at 120° C. before the pellets were subjected to injection molding. The injection molding machine, Fanuc Roboshot S-2000i100BH (available from Fanuc), was used for the injection molding process. The compounded samples were subjected to injection molding to produce specimens and to conduct impact testing on the specimens using the impact strength test described herein below. The parameters for the injection molding machine and process were as follows: the barrel temperature for the injection screw was set between 250° C. and 260° C., the cooling temperature was 190° C., the cooling time was 15 s, the injection rate was 30 mm/s, and the injection pressure was 200 MPa.

### Impact Strength Test

The impact strength testing method used for testing the impact performance of the specimens prepared in the Examples is described in CHARPY, ISO 179 (“ISO” stands for “International Organization for Standardization”). CHARPY, ISO 179 specifies a method for determining the Charpy impact strength of plastics under defined conditions. Each of the specimens used in the test is a flat test specimen made from the formulations of Tables II to Table V; and having the following dimensions: 80 mm in length×10 mm in width×4 mm in thickness. CHARPY, ISO 179 defines the method used to determine the resistance of plastic to breaking when impacted in a three-point bend configuration, using a pendulum system with an appropriately sized hammer arm. The test is un-instrumented and is used to determine the energy required to break a specimen. Different test parameters are specified according to the type of material that the specimen is made of, as well as the type of notch cut in the specimen to be tested.

In the Examples described herein, the following general procedure was followed: all specimens were notched with a 2 mm radius notch. Before the specimens were tested, all specimens were first dried at 120° C. for 4 hr in a dehumidifier. The specimens were subsequently equilibrated at room temperature in the dehumidifier for 2 days.

Each of the specimens to be tested was mounted horizontally on a pendulum impact testing machine and supported unclamped at both ends. The hammer of the testing machine was released and allowed to strike through the specimen. If breakage did not occur with the first hammer arm used, a heavier hammer was used sequentially until failure occurred. Then upon breakage, the resulting energy and break types were recorded.

The impact test conditions used were as follows: a pendulum capacity of 4 Joules and a specimen conditioning at ≥6 hr at room temperature or ≥6 hr at −30° C. and/or −40° C. in a freezer. The specimens in the freezer were removed from the freezer and impact tested within 5 s. The test conditions were at room temperature (i.e., a temperature of 23° C.±2° C.) and a 50% RH±10% RH.

### Test Results

The viscosity results of the toughened nylon formulations were obtained by conducting the above-described Capillary Viscosity Test; and the viscosity results for the Series 1 experiments are described in Table VI; and the viscosity results for the Series 2 experiments are described in Table VII. The normalized capillary viscosity results were calculated by dividing the capillary viscosity value of the sample by the capillary viscosity value of the particular Comparative Example which is indicated in the column heading in the Tables below; that value was then multiplied by 100 to convert to a percentage. The normalized Izod impact results were also calculated by dividing the Izod impact value of the sample by the Izod impact value of the particular Comparative Example which is indicated in the column heading in the Tables below; that value was then multiplied by 100 to convert to a percentage.

TABLE VI
Viscosity of Formulation—Series 1 (POE-g-MAH1)

| | | | Normalized |
|---|---|---|---|
| | | PDMS | Capillary |
| | | Loading | Viscosity |
| | | Based | Compared |
| | | on Nylon | to Comp. |
| Example | | Composite | Ex. A @ |
| No. | Formulation | (wt %) | 770 s⁻¹⁽¹⁾ |
| Comp. Ex. A | Control (no PDMS) | 0.00 | 100% |
| Inv. Ex. 1 | KF-6000 | 0.24 | — |
| Inv. Ex. 2 | KF-6000 | 0.47 | 102% |
| Inv. Ex. 3 | KF-6000 | 0.95 | 96% |
| Inv. Ex. 4 | KF-6001 | 0.44 | — |
| Inv. Ex. 5 | KF-6001 | 0.93 | — |
| Inv. Ex. 6 | KF-8010 | 0.44 | 78% |
| Inv. Ex. 7 | KF-8010 | 0.88 | 71% |
| Inv. Ex. 8 | X-22-161A | 0.47 | 91% |
| Inv. Ex. 9 | X-22-161A | 0.81 | 71% |
| Inv. Ex. 10 | X-22-162C | 0.47 | 97% |
| Inv. Ex. 11 | X-22-162C | 0.94 | 78% |
| Inv. Ex. 12 | PMX-200 Fluid 10 cSt | 0.40 | 90% |
| Inv. Ex. 13 | PMX-200 Fluid 10 cSt | 0.70 | 94% |
| Inv. Ex. 14 | PMX-200 Fluid 10 cSt | 1.00 | 92% |
| Inv. Ex. 15 | PMX-200 Fluid 20 cSt | 0.47 | 91% |
| Inv. Ex. 16 | PMX-200 Fluid 20 cSt | 0.93 | 92% |
| Inv. Ex. 17 | PMX-200 Fluid 100 cSt | 0.50 | 116% |
| Inv. Ex. 18 | PMX-200 Fluid 1K cSt | 0.40 | 88% |
| Inv. Ex. 19 | PMX-200 Fluid 10K cSt | 0.40 | 88% |
| Inv. Ex. 20 | PMX-200 Fluid 60K cSt | 0.93 | 97% |
| Comp. Ex. B | DOWSIL ™ SGM 15 GUM | 0.50 | 93% |
| Comp. Ex. C | DOWSIL ™ SGM 15 GUM | 0.93 | 88% |

Notes for Table VI: ⁽¹⁾ A lower viscosity is better and desired.

TABLE VII
Viscosity of Formulation—Series 2 (POE-g-MAH2)

| | | | Normalized |
|---|---|---|---|
| | | PDMS | Capillary |
| | | Loading | Viscosity |
| | | Based | Compared to |
| | | on Nylon | Comp. Ex. |
| | | Composite | D or E @ |
| Example No. | Formulation | (wt %) | 770 s⁻¹⁽¹⁾ |
| Comp. Ex. D | Control (no PDMS) | 0.00 | 100% |
| Comp. Ex. E | Control (no PDMS) | 0.00 | 100% |
| Inv. Ex. 21 | KF-6000 | 0.95 | 88% |
| Inv. Ex. 22 | PMX-200 Fluid 10 cSt | 0.70 | 96% |
| Inv. Ex. 23 | PMX-200 Fluid 20 cSt | 0.47 | 100% |
| Inv. Ex. 24 | PMX-200 Fluid 20 cSt | 0.93 | 107% |
| Inv. Ex. 25 | PMX-200 Fluid 100 cSt | 0.50 | 110% |
| Inv. Ex. 26 | PMX-200 Fluid 1K cSt | 0.40 | 96% |
| Inv. Ex. 27 | PMX-200 Fluid 1K cSt | 1.00 | 92% |
| Inv. Ex. 28 | PMX-200 Fluid 1K cSt | 0.40 | 105% |
| Inv. Ex. 29 | PMX-200 Fluid 1K cSt | 0.75 | 100% |
| Inv. Ex. 30 | PMX-200 Fluid 1K cSt | 1.50 | 93% |

Notes for Table VII:
⁽¹⁾A lower viscosity is better and desired.

The impact strength results of injection molded test specimens made from the toughened nylon formulations were obtained by conducting the above-described Impact Strength Test on the injection molded specimens prepared according to the injection molding method above. The impact strength results for the Series 1 experiments are described in Table VIII and the impact strength results for the Series 2 experiments are described in Table IX.

TABLE VIII
Impact Strength—Series 1 (POE-g-MAH1)

| | | | Norma- | Norma- | |
|---|---|---|---|---|---|
| | | | lized | lized | |
| | | PDMS | Izod | Izod | |
| | Formulation | Loading | Impact | Impact | |
| | Example | Based | @ RT | @−30° C. | |
| Example | Used to | on Nylon | Com- | Com- | |
| No. of | Make | Com- | pared | pared | Flexural |
| Specimen | Specimen | posite | to Comp. | to Comp. | Modulus |
| Tested | for Testing | (wt %) | Ex. F | Ex. F | (MPa)⁽¹⁾ |
| Comp. | Comp. | 0.00 | 100% | 100% | 1,585 |
| Ex. F | Ex. A | | | | |
| Inv. Ex. 31 | Inv. Ex. 1 | 0.24 | 166% | — | — |
| Inv. Ex. 32 | Inv. Ex. 2 | 0.47 | 175% | — | 1,508 |
| Inv. Ex. 33 | Inv. Ex. 3 | 0.95 | 138% | — | — |
| Inv. Ex. 34 | Inv. Ex. 4 | 0.44 | 174% | — | — |
| Inv. Ex. 35 | Inv. Ex. 5 | 0.93 | 164% | — | — |
| Inv. Ex. 36 | Inv. Ex. 6 | 0.44 | 176% | — | — |
| Inv. Ex. 37 | Inv. Ex. 7 | 0.88 | 181% | — | 1,642 |
| Inv. Ex. 38 | Inv. Ex. 8 | 0.47 | 131% | 234% | — |
| Inv. Ex. 39 | Inv. Ex. 9 | 0.81 | 187% | — | — |
| Inv. Ex. 40 | Inv. Ex. 10 | 0.47 | — | 169% | — |
| Inv. Ex. 41 | Inv. Ex. 11 | 0.94 | 180% | 166% | — |
| Inv. Ex. 42 | Inv. Ex. 12 | 0.40 | 190% | 182% | 1,665 |
| Inv. Ex. 43 | Inv. Ex. 13 | 0.70 | 187% | 222% | 1,993 |
| Inv. Ex. 44 | Inv. Ex. 14 | 1.00 | 186% | 220% | 1,763 |
| Inv. Ex. 45 | Inv. Ex. 15 | 0.47 | 132% | 226% | — |
| Inv. Ex. 46 | Inv. Ex. 16 | 0.93 | 131% | 116% | — |
| Inv. Ex. 47 | Inv. Ex. 17 | 0.50 | — | 175% | 1,600 |
| Inv. Ex. 48 | Inv. Ex. 18 | 0.40 | 172% | 103% | — |
| Inv. Ex. 49 | Inv. Ex. 19 | 0.40 | 166% | 105% | — |
| Inv. Ex. 50 | Inv. Ex. 20 | 0.93 | 126% | 204% | — |
| Comp. | Comp. | 0.50 | 127% | 107% | — |
| Ex. G | Ex. B | | | | |
| Comp. | Comp. | 0.93 | 124% | 94% | — |
| Ex. H | Ex. C | | | | |

Notes for Table VIII:
⁽¹⁾A higher flexural modulus value is better or is not significantly reduced compared to the control; these values are desired.

TABLE IX
Impact Strength - Series 2 (POE-g-MAH2)

| | | PDMS | Normalized | Normalized | Normalized | |
|---|---|---|---|---|---|---|
| | Formulation | Loading | Izod | Izod | Izod | |
| Example | Example | Based on | Impact @ RT | Impact @ −30° C. | Impact @ −40° C. | |
| No. of | Used to Make | Nylon | Compared | Compared | Compared | Flexural |
| Specimen | Specimen for | Composite | to Comp. | to Comp. | to Comp. | Modulus |
| Tested | Testing | (wt %) | Ex. I | Ex. I | Ex. I | (MPa) |
| Comp. Ex. I | Comp. Ex. D | 0.00 | 100% | 100% | 100% | 1,603 |
| Comp. Ex. J | Comp. Ex. E | 0.00 | 100% | — | — | — |
| Inv. Ex. 51 | Inv. Ex. 21 | 0.95 | 201% | — | 106% | 1,721 |
| Inv. Ex. 52 | Inv. Ex. 22 | 0.70 | 196% | 121% | — | 2,113 |
| Inv. Ex. 53 | Inv. Ex. 23 | 0.47 | 202% | 216% | 112% | — |
| Inv. Ex. 54 | Inv. Ex. 24 | 0.93 | 202% | 235% | 119% | — |
| Inv. Ex. 55 | Inv. Ex. 25 | 0.50 | — | 181% | 113% | 1,654 |
| Inv. Ex. 56 | Inv. Ex. 26 | 0.40 | 144% | — | — | — |
| Inv. Ex. 57 | Inv. Ex. 27 | 1.00 | 168% | — | — | — |
| Inv. Ex. 58 | Inv. Ex. 28 | 0.40 | 144% | — | — | — |
| Inv. Ex. 59 | Inv. Ex. 29 | 0.75 | 147% | — | — | — |
| Inv. Ex. 60 | Inv. Ex. 30 | 1.50 | 121% | — | — | — |

### Discussion of Results

In the Series 1 experiments, different types of PDMS (carbinol, amino, carboxyl and nonfunctionalized) were soaked into POE-g-MVAH1 with different PDMS loadings. Then the PDMS soaked POE was compounded with PA6 B33s (a mid-viscosity polyamide nylon (Nylon 6) available from BASF). The capillary viscosity properties of the formulations in the Series 1 experiments are described in Table VI, and the impact strength properties of the specimens made from the formulations are described in Table VIII.

When comparing the toughened polyamide composition of the present invention to a control formulation, e.g., the toughened polyamide nylon PA6 B3s which is toughened by the toughener POE-g-MAH1, all the of the Inventive Examples exhibited significant improvement on the room temperature impact strength property of the toughened polyamide compositions containing PDMS. The samples of the toughened polyamide compositions of the present invention toughened with the POE and containing the PDMS additives also exhibited significant improvement on the impact strength property at a low temperature of −30° C. In addition, the inventive examples demonstrated flexural modulus performance that was either maintained or improved versus the Comparative Example.

The results support the conclusion that PDMS additives can significantly improve the toughening efficiency of POE. Moreover, there is no significant difference on impact strength whether the PDMS is functionalized or not functionalized. Also, the viscosity (which correlates to molecular weight) of PDMS did not show remarkable difference on impact strength at room temperature for the toughened polyamide composition; however, a higher viscosity PDMS (which correlates to a higher molecular weight PDMS) indicated less improvement on impact strength at −30° C. for the toughened polyamide composition. For example, when comparing the −30° C. impact strength of a toughened polyamide composition containing the PDMSs, PMX-200 Fluid 10 cSt to PMX-200 Fluid 100 cSt, (Inv. Ex. 12-17) with a toughened polyamide composition containing the PDMSs, PMX-200 Fluid 1k cSt and PMX-200 Fluid 10k cSt (Inv. Ex. 18 and 19), higher viscosity PMX-200 Fluid PDMS (which means a higher Mw PMX-200 Fluid PDMS) has much less improvement on −30° C. impact strength of a toughened polyamide composition. To be noted, in the Series 1 experiments, since PMX-200 Fluid 1k cSt and PMX-PMX-200 Fluid 10kcSt PDMSs have a high Mw property, these two PDMS samples cannot be soaked into POE; these two PDMS samples were first compounded with POE under 100° C. using the compounding method instead of the soaking method.

Besides the impact strength, the amino and carboxyl PDMSs indicated a significant decrease in capillary viscosity. Tables VI and VII describes the capillary viscosity of PDMSs at 770-s (the typical shear of a capillary viscosity test). The results show that around a 30% decrease of the viscosity of the PDMSs occurs. It is possible that an amine or an organic acid could improve the flowability of toughened nylon compositions.

In the Series 2 experiments, various PDMSs were mixed with POE-g-MAH2 with different PDMS loadings. The capillary viscosity properties of the formulations in the Series 2 experiments are described in Table VII and the impact strength impact strength properties of the specimens made from the formulations are described in Table IX. The results in Table IX indicate the same improvement on impact strength at room temperature and at a temperature of −30° C. The formulations with a 15% POE loading were also inspected, and the improvement trend is the same. For the formulations with too high of a PDMS loading (e.g., 10% of PDMS in POE), the results indicate a drop of impact strength at room temperature compared to a formulation with a 2% to 5% PDMS loading. It has unexpectedly been found that the results of PDMS dosage in toughened polyamide compositions can affect impact strength improvement and therefore, a proper selection of the PDMS loading is needed to provide the desired impact strength of the toughened polyamide compositions.

1. A toughened polyamide composition comprising:
(a) at least one polyamide;
(b) at least one toughener component; and
(c) at least one siloxane-based component having a viscosity of from 1 mm²/s to 100,000 mm²/s for providing a toughened polyamide composition having an increased impact strength.

2. The toughened polyamide composition of claim 1, wherein the functionalized polar end groups in the at least one siloxane-based component includes a hydroxyl group; an amino group; an epoxy group; a carboxyl group; a mercapto group, and mixtures thereof.

3. The toughened polyamide composition of claim 1, wherein the non-functionalized non-polar end groups in the at least one siloxane-based component includes an allyl group; an alkyl group; and mixtures thereof.

4. The toughened polyamide composition of claim 1, wherein the concentration of the at least one polyamide, component (a), is from 50 percent by weight to 98.99 percent by weight; wherein the concentration of the at least one toughener component, component (b), is from 1 percent by weight to 50 percent by weight; and wherein the concentration of the at least one siloxane-based component is from 0.01 percent by weight to 10 percent by weight based on the total weight of toughened polyamide composition.

5. The toughened polyamide composition of claim 1, wherein the polyamide, component (a), is selected from the group consisting of: (ai) Nylon-4,6; (aii) Nylon-6,6;
(aiii) Nylon-6,10; (aiv) Nylon-6,9; (av) Nylon-6,12; (avi) Nylon-11; (avii) Nylon-12; (aviii) 6T through 12T; (aix) 61 through 121; (ax) polyamides formed from 2-methylpentamethylene diamine and/or from hexamethylene diamine with one or more acids selected from the group consisting of adipic acid, isophthalic acid and terephthalic acid; and (axi) blends and/or copolymers of said nylons and polyamides thereof.

6. The toughened polyamide composition of claim 1, wherein the toughened polyamide composition exhibits at least a 10 percent increase in impact strength compared to a polyamide composition not containing the at least one siloxane-based component.

7. The toughened polyamide composition of claim 1, wherein the composition further comprises up to 50 percent by weight, based on the composition, of a component selected from the group consisting of fillers, lubricants, plasticizers, pigments, dyes, antioxidants, stabilizers, nucleating agents, flame retardants, blowing agents, and combinations thereof.

8. A process for preparing a toughened polyamide composition exhibiting high flow and toughness comprising melt-mixing, in one step and at a predetermined temperature and for a predetermined period of time:
(a) at least one polyamide;
(b) at least one toughener component; and
(c) at least one siloxane-based component having a viscosity of from 1 mm²/s to 100,000 mm²/s for providing a toughened polyamide composition having an increased impact strength; wherein the melt-mixing of components (a) to (c) is carried out at a temperature of greater than 200° C.

9. A process for preparing a toughened polyamide composition exhibiting high flow and toughness comprising the steps of:
(I) mixing, at a temperature of less than 60° C.; at least the following two components to form a blend composite component:
(α) at least one toughener component; and
(β) at least one siloxane-based component; and
(II) melt-mixing, at a temperature of greater than 200° C.; at least the following two components to form a toughened polyamide composition having an increased impact strength:
(γ) at least one polyamide; and
(ε) the blend composite component from step (I).

10. (canceled)

11. An article manufactured from the toughened polyamide composition of claim 1.
